(19) United States
(12) Patent Application Publication
(10) Pub. No.: US 2026/0008121 A1
(43) Pub. Date: Jan. 8, 2026

(54) LASER PROCESSING DEVICE USING OBJECTIVE LENS AND METHOD OF OPERATING THE SAME

(71) Applicant: XELIN CO., LTD., Bucheon-si (KR)

(72) Inventors: Sang Wook JEON, Seoul (KR); Jang Su JEON, Incheon (KR); Se In YI, Seoul (KR)

(73) Assignee: XELIN CO., LTD., Bucheon-si (KR)

(21) Appl. No.: 18/938,737

(22) Filed: Nov. 6, 2024

(30) Foreign Application Priority Data
Jul. 2, 2024 (KR) 10-2024-0086534

(51) Int. Cl. B23K 26/06

(52) U.S. Cl. CPC B23K 26/0648

(57) ABSTRACT

Disclosed are a laser processing device and a method of operating the same. A laser processing device according to an embodiment of the present disclosure includes a reflective mirror that rotationally vibrates with respect to one point of a mirror, receives a laser point from a laser output device incident on the one point, and reflects the laser point incident on the one point in a different direction from an output direction of the laser output device and an objective lens, on which the laser point reflected by the reflective mirror is incident and which generates a laser line having a width determined by the rotational vibration by refracting the laser point and outputs the laser line to a workpiece.

### CROSS-REFERENCE TO RELATED APPLICATION

This application claims priority to and the benefit of Korean Patent Application No. 10-2024-0086534 filed on Jul. 2, 2024, the disclosure of which is incorporated herein by reference in its entirety.

### BACKGROUND

### 1. Field of the Invention

The present disclosure relates to an electronic device. More particularly, the present disclosure relates to a laser processing device using an objective lens and a method of operating the same.

### 2. Discussion of Related Art

Laser processing devices are used to process fine workpiece objects in various manners, such as welding, cutting, hole drilling, and marking of workpieces. The laser processing devices belong to the field of advanced processing devices or systems that require all of optical technology of a laser itself, processing application technology, and driving unit control technology. The laser processing devices are also used in a process of manufacturing a semiconductor chip. For example, the laser processing devices may radiate a processed laser on a workpiece and thus cut the workpiece in a shape desired by a user. In detail, product information, such as a product name, a manufacturing number, a manufacture date, and a logo may be printed on a surface of a small product, such as a semiconductor chip.

In general, an F-theta lens and a galvanometer scanner are used in the laser processing devices, and since a size of the F-theta lens is relatively large and a focus of laser generated in the workpiece is also relatively large, the laser processing devices are not suitable for use in semiconductor-related ultra-fine processes.

### SUMMARY OF THE INVENTION

The present invention is directed to providing a system capable of being easily applied to processes such as laser microprocessing, cutting, grooving, an ultra-fine process that requires reduced laser degradation, semiconductor dicing, and printing of product information on a semiconductor chip.

The aspects of the present disclosure are not limited to the aspects described above, and those skilled in the art will clearly understand other aspects not described based on the following description.

A laser processing device according to an aspect of the present disclosure includes a reflective mirror that rotationally vibrates with respect to one point of a mirror, receives a laser point from a laser output device incident on the one point, and reflects the laser point incident on the one point in a different direction from an output direction of the laser output device and an objective lens, on which the laser point reflected by the reflective mirror is incident, and which generates a laser line having a width determined by the rotational vibration by refracting the laser point and outputs the laser line to a workpiece.

A method of operating a laser processing device according to another aspect of the present disclosure includes reflecting a laser point from a laser output device incident on one point of a reflective mirror in a different direction from an output direction of the laser output device based on rotational vibration of the reflective mirror with respect to the one point of the reflective mirror and outputting a laser line having a width that is determined by the rotational vibration to a workpiece by refracting the laser point reflected by the reflective mirror.

### BRIEF DESCRIPTION OF THE DRAWINGS

The above and other objects, features, and advantages of the present disclosure will become more apparent to those of ordinary skill in the art by describing exemplary embodiments thereof in detail with reference to the accompanying drawings, in which:

FIG. 1 is a block diagram of a system according to a comparative example;

FIG. 2 is a view for describing a laser that is condensed through an F-theta lens of FIG. 1;

FIG. 3 is a block diagram of a system according to an exemplary embodiment of the present disclosure;

FIG. 4 is a diagram for describing a laser processing device according to an exemplary embodiment of the present disclosure;

FIG. 5 is a view illustrating an example of a shape of a laser Gaussian beam;

FIG. 6 is a graph illustrating an intensity of the laser Gaussian beam of FIG. 5;

FIG. 7 is a view illustrating an example of a shape of a laser beam;

FIG. 8 is a view for describing an exemplary embodiment in which a laser line of the present disclosure is generated;

FIGS. 9A and 9B are views illustrating processing lines generated on a workpiece according to an example of the present disclosure and processing lines generated according to a comparative example;

FIG. 10 is a view illustrating examples of objective lenses having various numerical apertures of the present disclosure; and

FIG. 11 is a flowchart of a method of operating the laser processing device according to an exemplary embodiment of the present disclosure.

### DETAILED DESCRIPTION OF EXEMPLARY EMBODIMENTS

Throughout the present disclosure, the same reference numerals refer to the same components. The present disclosure does not describe all components of embodiments, and general contents or duplicated contents between the embodiments in the technical field to which the present disclosure pertains will be omitted. The terms “unit, module, member, and block” used herein may be implemented in software or hardware, and according to embodiments, the plurality of “units, modules, members, and blocks” may be implemented in one component or one “unit, module, member, and block” may include a plurality of components.

Throughout the specification, when it is described that a first component is “connected” to a second component, this includes not only a case in which the first component is directly connected to the second component but also a case in which the first component is indirectly connected to the second component, and the indirect connection includes connection through a wireless communication network.

Further, when a part “includes” a component, this means that a third component is not excluded but may be further included unless otherwise stated.

Throughout the specification, when a first member is located “on” a second member, this case includes not only a case in which the first member is in contact with the second member but also a case in which a third member is present between the two members.

Terms such as first and second are used to distinguish one component from another component, and components are not limited by the above-described terms.

Singular expressions include plural expressions unless clearly otherwise indicated in the context.

In each operation, an identification code is used for convenience of description and does not describe a sequence of the operations, and an operation may be performed in a different order from a specified order unless the context clearly states a specific order.

Hereinafter, the operating principles and embodiments of the present disclosure will be described with reference to the accompanying drawings.

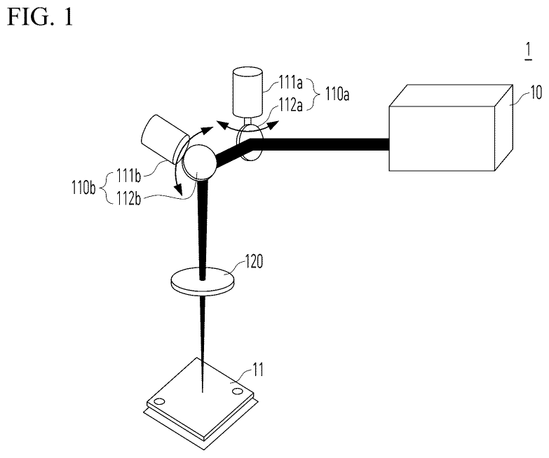

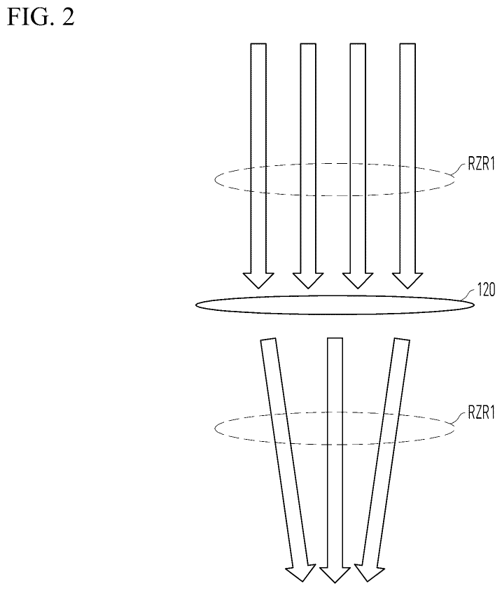

FIG. 1 is a block diagram of a system according to a comparative example, and FIG. 2 is a view for describing a laser that is condensed through an F-theta lens of FIG. 1.

Referring to FIGS. 1 and 2, a system 1 according to the comparative example may include a laser oscillator 10, a first galvanometer scanner 110a, a second galvanometer scanner 110b, an F-theta lens 120, and an object 11. The laser oscillator 10 may output a laser. The first galvanometer scanner 110a and second galvanometer scanner 110b may deflect the laser using a mirror to sense a current and reflect the laser. The first galvanometer scanner 110a and the second galvanometer scanner 110b may swing at a specific angle according to an input position signal, a specific voltage of a motor, and a conversion ratio of an angle. The first galvanometer scanner 110a and the second galvanometer scanner 110b may include a first servomotor 111a, a second servomotor 111b, a first scanning mirror 112a, and a second scanning mirror 112b. However, the present disclosure is not limited thereto, and the first galvanometer scanner 110a and the second galvanometer scanner 110b may further include a position sensor, a control circuit, an error amplifier, a power amplifier, a position classifier, and the like. The first servomotor 111a and the second servomotor 111b may rotate to very finely and quickly move the first scanning mirror 112a and the second scanning mirror 112b. For example, the first servomotor 111a may move the first scanning mirror 112a, and the second servomotor 111b may move the second scanning mirror 112b. The first scanning mirror 112a and the second scanning mirror 112b may reflect the laser through fine vibration. For example, the first scanning mirror 112a may reflect the laser of the laser oscillator 10, and the second scanning mirror 112b may reflect the laser reflected by the first scanning mirror 112a. A distance between the first scanning mirror 112a and the second scanning mirror 112b may be changed according to movement or angle changes of the first scanning mirror 112a and the second scanning mirror 112b, and an actual position of the laser may be distorted. The F-theta lens 120 may be used to always keep a laser focal length constant regardless of an angle at which the laser is incident. Referring to FIGS. 1 and 2, for example, a first laser RZR1 may be a laser reflected by the second scanning mirror 112b. When the first laser RZR1 is incident on the F-theta lens 120, the F-theta lens 120 may refract the first laser RZR1. As the first laser RZR1 is refracted by the F-theta lens 120, a second laser RZR2 may be condensed into one focus point. The laser refracted and condensed by the F-theta lens 120 may be radiated on the object 11. The object 11 may be, for example, a semiconductor chip, but the present disclosure is not limited thereto. A size of the F-theta lens 120 of FIGS. 1 and 2 may be much larger than a size of a lens such as an objective lens, and a size of the laser generated on a workpiece such as the object 11 may be very large compared to the lens such as the objective lens. Thus, it is difficult to apply the system 1, to which the F-theta lens 120 is applied, to processes such as a semiconductor dicing process for producing a semiconductor die.

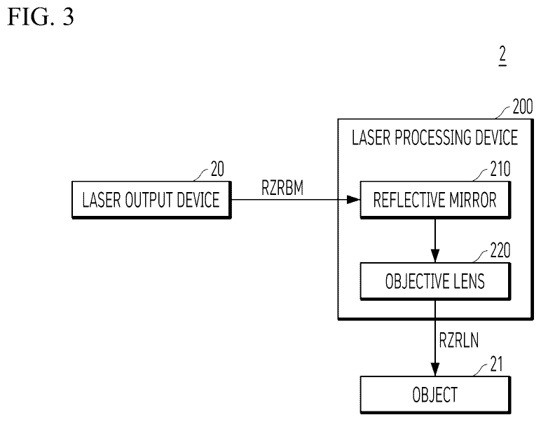

FIG. 3 is a block diagram of a system according to an exemplary embodiment of the present disclosure.

Referring to FIG. 3, a system 2 may include a laser output device 20, a laser processing device 200, and an object 21.

The laser output device 20 may output a laser point RZRBM. For example, the laser output device 20 may be implemented as the laser oscillator 10 of FIG. 1, but the present disclosure is not limited thereto. The laser point RZRBM may be a laser having a constant beam shape.

The laser processing device 200 is a device capable of processing a laser incident on a mirror as a dot into a straight line laser. In this case, the mirror, on which the laser point RZRBM is incident, may vibrate, and a laser having a line shape may be generated in a vibration direction. For example, the laser processing device 200 may generate a laser line RZRLN having a constant width based on the laser point RZRBM output from the laser output device 20 and radiate the laser line RZRLN on the object 21.

In an exemplary embodiment, the laser processing device 200 may include a reflective mirror 210 and an objective lens 220. The reflective mirror 210 may rotationally vibrate with respect to one point of the mirror. Further, the reflective mirror 210 may receive the laser point RZRBM incident on one point from the laser processing device 200. Further, the reflective mirror 210 may reflect the laser point RZRBM incident on the one point in a direction that is different from an output direction of the laser output device 20. The laser point RZRBM reflected by the reflective mirror 210 may be incident on the objective lens 220. The objective lens 220 may refract the laser point RZRBM to generate the laser line RZRLN having a width that is determined by the rotational vibration of the reflective mirror 210. Further, the objective lens 220 may output the laser line RZRLN to the object 21. The object 21 may be referred to as the workpiece.

A size of the objective lens 220 may be smaller than a size of the F-theta lens 120 of FIG. 1, a size of a laser generated by the objective lens 220 and radiated on the object 21 may be very small in comparison to the F-theta lens 120, and thus the system 2 of the present disclosure may be easily used in a process such as semiconductor dicing. That is, the size of the objective lens 220 is smaller than the size of the F-theta lens 120, a width of the laser line is very narrow in comparison to the F-theta lens 120, and thus the system 1 of the present disclosure can be easily used to process semiconductors.

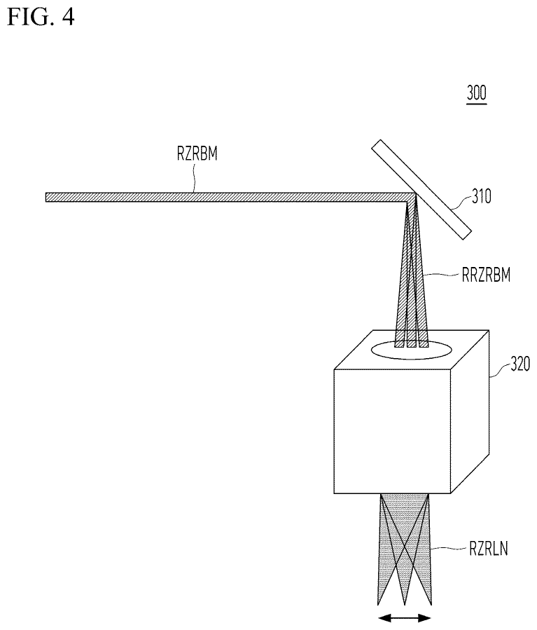

FIG. 4 is a diagram for describing a laser processing device according to an exemplary embodiment of the present disclosure.

Referring to FIG. 4, a laser processing device 300 may correspond to the laser processing device 200 of FIG. 3. In an exemplary embodiment, the laser processing device 300 may include a plane mirror 310 and an objective lens 320.

The plane mirror 310 may be an example of the reflective mirror 210 of FIG. 3. The plane mirror 310 may rotationally vibrate while being inclined toward the laser output device 20. When the plane mirror 310 vibrates, an incident angle of the incident laser point RZRBM may vary. The laser point RZRBM may be incident on the plane mirror 310, the laser point RZRBM may be reflected by the plane mirror 310 that rotationally vibrates, and the reflected laser point RRZRBM may be incident on the objective lens 320.

However, the reflective mirror 210 of the present disclosure is not limited only to the plane mirror 310 but may further include a concave mirror and a convex mirror. When the concave mirror is used, energy density of the laser can be increased.

The objective lens 320 may be an example of the objective lens 220 of FIG. 3. A reflective point of the laser point RZRBM incident on the mirror may not be changed, an incident angle of the laser point RZRBM may be changed, and an angle of a condensed laser beam (e.g., the laser line RZRLN) formed through the objective lens 320 may be changed. The objective lens 320 may have a predetermined numerical aperture. A focal length and a focal size may be determined according to the numerical aperture of the objective lens 320. Further, a size of the laser line RZRLN (e.g., a length of a beam forming section) may be changed according to the numerical aperture of the objective lens 320. A shape of the beam forming section may be a line shape.

In an exemplary embodiment, when the reflected laser point RRZRBM is incident on the objective lens 320, a laser vibrating beam may be incident on the workpiece only as much as the numerical aperture allows, an amplitude (e.g., a degree of change in an amount of variation width caused by the vibrating beam) allowed by the objective lens 320 may be about 100 μm, but the present disclosure is not limited thereto. For example, when the numerical aperture is 0.4, a maximum amplitude allowed by the objective lens 320 may be 50 μm, but the present disclosure is not limited thereto.

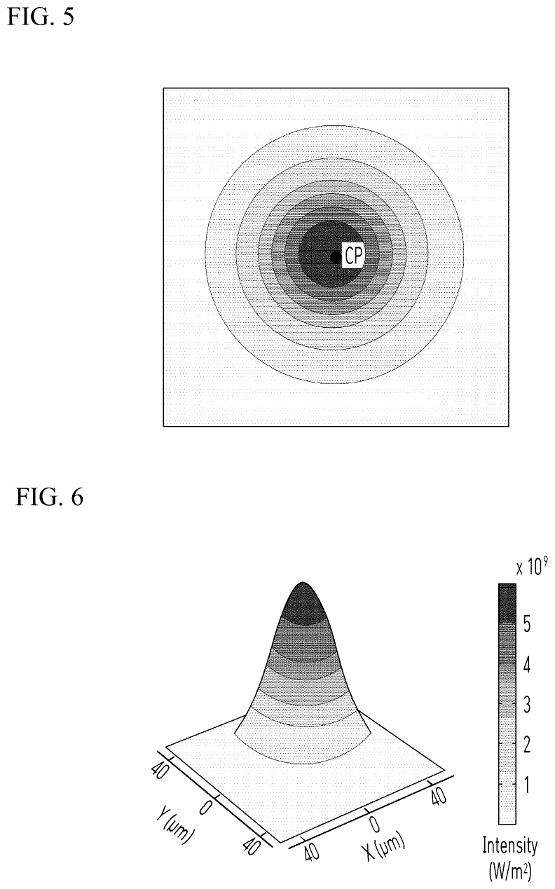

FIG. 5 is a view illustrating an example of a shape of a laser Gaussian beam, and FIG. 6 is a graph illustrating an intensity of the laser Gaussian beam of FIG. 5. Referring to FIGS. 5 and 6, in an exemplary embodiment, the laser point RRZRBM may be a laser beam radiated during an irradiation time of 1 picosecond or less. That is, only when the laser point RRZRBM is a laser beam radiated during an irradiation time of a femtosecond unit the object 21 can be etched into a shape desired by the user. When a laser having a long pulse width of 1 picosecond or more is used, due to laser heat, a degree of cutting may be insufficient or excessive in comparison to a required degree. The laser beam according to an exemplary embodiment may have the shape of the laser Gaussian beam. The strength (intensity) of the laser beam may be greatest at a center CP according to the shape of the laser Gaussian beam.

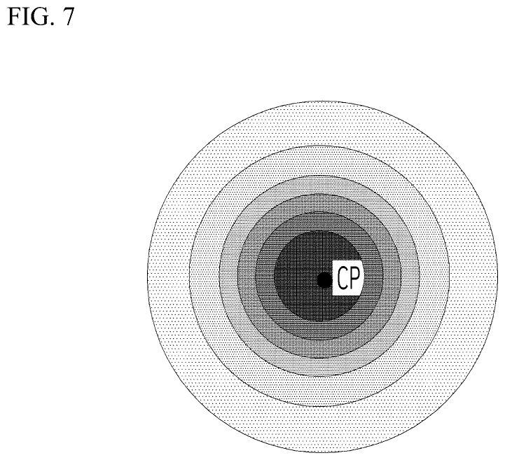

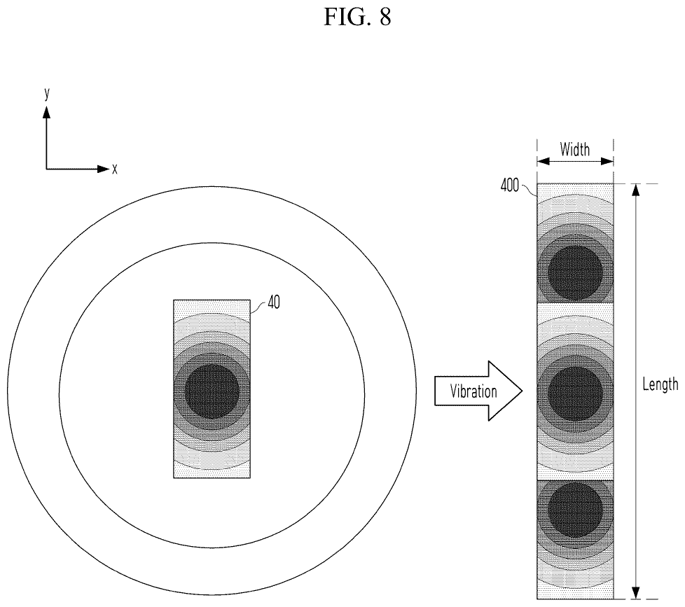

FIG. 7 is a view illustrating an example of a shape of a laser beam, and FIG. 8 is a view for describing an exemplary embodiment in which a laser line of the present disclosure is generated.

Referring to FIG. 7, the laser point RRZRBM according to the embodiment may have a circular shape having the greatest intensity at a center thereof.

Referring to FIG. 8, the laser point RRZRBM according to another embodiment may have a shape of a laser beam 40 of which both sides are cut. In detail, the laser point RRZRBM incident on the reflective mirror 210 may be output by the laser output device 20, sides of the laser output device 20 may be blocked, and thus the laser point RRZRBM may have a quadrangular beam-shaping shape.

For example, since the sides of the laser output device 20 outputting the circular laser point RRZRBM of FIG. 7 are blocked and a segment is removed from the circular laser point RRZRBM because the sides are blocked, the laser point RRZRBM may have a quadrangular beam-shaping shape.

When the beam-shaped laser point RRZRBM is reflected due to the rotational vibration of the reflective mirror 210, the line-shaped laser line RZRLN may be formed. For example, a width of the laser line RZRLN may be formed in a vibrational direction of the rotational vibration. In an exemplary embodiment, the intensity of the laser beam incident on the laser line RZRLN may be the strongest at the center CP of the laser line RZRLN in a width direction. The workpiece, for example, the object 21, may be etched most at the center CP of the width by the laser line RZRLN. As a result, when viewed in a width direction of the laser line RZRLN, the center in the width direction may be dug the deepest, and thus the workpiece, for example, the object 21, may be cut into a V shape due to the laser line RZRLN.

Accordingly, the generated laser line RZRLN may process the workpiece while moving in an x-axis direction or a y-axis direction. Illustratively, when the laser line RZRLN moves in the y-axis direction, the workpiece may be dug the deepest in the center of the laser line RZRLN in the width direction and cut in a V shape. When the laser line RZRLN moves in the x-axis direction, the workpiece may be processed such that a surface thereof is relatively uniform as compared to a case in which the workpiece is processed while the laser line RZRLN moves in the y-axis direction.

A length of the laser line RZRLN may be several tens of times the focal size, and a laser having the corresponding focal size may generate the laser line RZRLN while vibrating back and forth in a longitudinal direction. That is, when the laser vibrates back and forth in the laser line RZRLN, time and space, for which heat caused by the processing may be cooled until the laser is radiated again after the laser has been radiated, may be generated, and accordingly, processing quality of the laser line RZRLN can be improved.

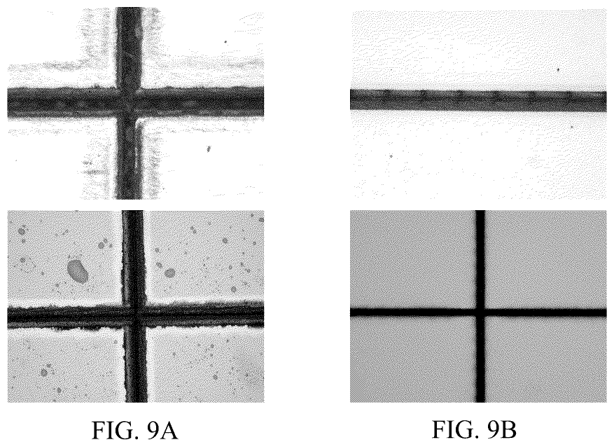

FIG. 9 is a view illustrating processing lines generated on the workpiece according to an example of the present disclosure and processing lines generated according to a comparative example.

In FIG. 9A, a laser line generated according to the comparative example may form non-uniform degradation marks around the laser line, and accordingly, processing quality may be degraded. This comparative example may be an example in which the workpiece is processed by a laser point with respect to a picosecond unit.

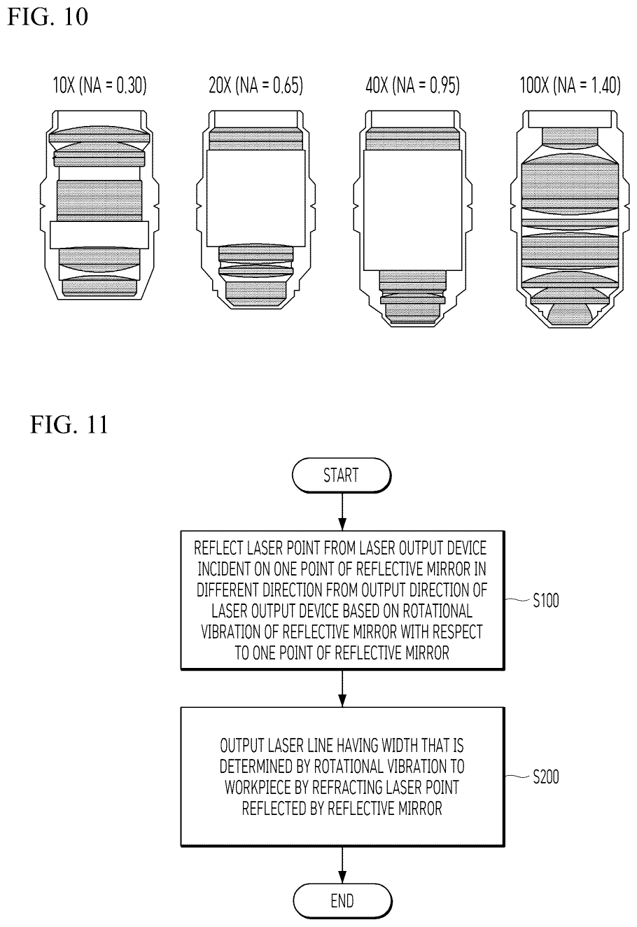

In contrast, in FIG. 9B, the laser point according to the example of the present disclosure is a laser point with respect to a femtosecond unit, and accordingly, the generated laser line may process the workpiece with high quality without forming non-uniform degradation marks around the processing lines as compared to FIG. 9A. FIG. 10 is a view illustrating examples of objective lenses having various numerical apertures of the present disclosure.

Referring to FIG. 10, in an exemplary embodiment, the objective lens 220 may have various numerical apertures. For example, the objective lens 220 may have a numerical aperture in a range of 0.1 to 1.4. Referring to FIG. 10, for example, the objective lens 220 may be implemented as an objective lens having a numerical aperture of 0.3, an objective lens having a numerical aperture of 0.65, an objective lens having a numerical aperture of 0.95, an objective lens having a numerical aperture of 1.4, or the like. Preferably, the numerical aperture of the objective lens 220 may be 0.4. Only when the objective lens having such a numerical aperture is included in the system 2, the object 21 can be cut into a shape desired by the user.

FIG. 11 is a flowchart of a method of operating the laser processing device according to an exemplary embodiment of the present disclosure.

Referring to FIGS. 3 and 11, an operation S100 of reflecting the laser point RZRBM from the laser output device 20 incident on one point of the reflective mirror 210 in a different direction from the output direction of the laser output device based on the rotational vibration of the reflective mirror 210 with respect to one point of the reflective mirror 210 is performed.

An operation S200 of outputting the laser line RZRLN having a width that is determined by the rotational vibration to the workpiece (e.g., the object 21) by refracting the laser point RZRBM reflected by the reflective mirror 210 is performed. According to the above description, a system that is easily applied to a semiconductor process can be constructed, and thus efficiency of semiconductor manufacturing can be increased.

According to the present disclosure, a system, which can reduce material deformation due to heat generated during laser processing and is easily applied to semiconductor-related fine processes, can be established, thereby increasing efficiency of semiconductor manufacturing.

The effects of the present disclosure are not limited to the effects described above, and those skilled in the art will clearly understand other effects not described based on the following description.

Embodiments disclosed with reference to the accompanying drawings have been described as above. Those skilled in the art to which the present disclosure pertains may understand that the present disclosure may be implemented in forms different from those of the disclosed embodiments without changing the technical spirit or essential features of the present disclosure. The disclosed embodiments are illustrative and should not be construed restrictively.

What is claimed is:

1. A laser processing device comprising:
a reflective mirror configured to rotationally vibrate with respect to one point of a mirror, receive a laser point from a laser output incident on the one point, and reflect the laser point incident on the one point in a different direction from an output direction of the laser output device; and
an objective lens on which the laser point reflected by the reflective mirror is incident and which generates a laser line having a width determined by the rotational vibration by refracting the laser point and outputs the laser line to a workpiece.

2. The laser processing device of claim 1, wherein the laser point incident on the reflective mirror is output by the laser output device and has a beam-shaping shape obtained by removing at least one segment from the circular laser point by blocking sides of the laser output device, and
the laser line is formed to have the width in a vibrational direction of the rotational vibration.

3. The laser processing device of claim 1, wherein an intensity of a laser beam incident on the laser line is strongest at a center of the laser line in a width direction, and
the workpiece is etched most at a center thereof in a width direction by the laser line.

4. The laser processing device of claim 3, wherein a portion of the workpiece, which corresponds to the center of the laser beam in the width direction, is etched deepest, and thus the workpiece is etched in a V shape in the width direction of the laser beam.

5. The laser processing device of claim 1, wherein the objective lens has a numerical aperture in a range of 0.1 to 1.4.

6. A method of operating a laser processing device, the method comprising:
reflecting a laser point from a laser output device incident on one point of a reflective mirror in a different direction from an output direction of the laser output device based on rotational vibration of the reflective mirror with respect to the one point of the reflective mirror; and
outputting a laser line having a width that is determined by the rotational vibration to a workpiece by refracting the laser point reflected by the reflective mirror.
